(19) United States
(12) Patent Application Publication
(10) Pub. No.: US 2009/0136117 A1
(43) Pub. Date: May 28, 2009

(54) METHOD AND APPARATUS FOR RESIDUE DETECTION ON A POLISHED WAFER

(75) Inventors: Arie Barkol, Kiron (IL); Moshe Gutman, Modi'in (IL); Haim Moshe Fireaizen, Neve Tzuf (IL); Aviva Peisach, Herzlia (IL); Moshe Rosenberg, Maccabim (IL)

Correspondence Address: FULBRIGHT AND JAWORSKI LLP, 555 S. FLOWER STREET, 41ST FLOOR, LOS ANGELES, CA, 90071, US

(73) Assignee: MAY HIGH-TECH SOLUTIONS LTD., KIRON (IL)

(21) Appl. No.: 11/718,085

(22) PCT Filed: Oct. 26, 2005
(86) PCT No.: PCT/IL05/01110

§ 371 Date: Apr. 26, 2007

Related U.S. Application Data
(60) Provisional application No. 60/622,443, filed on Oct. 26, 2004.

(51) Int. Cl. G06K 9/00

(52) U.S. Cl. 382/145

(57) ABSTRACT

There is provided an automatic optical inspection tool of an apparatus for residue detection on polished wafers, including an inspection tool, an illumination source, capable of instantaneous entire wafer surface illumination, colour digital camera, encompassing the entire wafers surface without eclipse, in a duple of consecutive, properly delayed imaging shots and providing appropriate image resolution for tiny residue detection, computation means, implementing image processing and manipulation algorithms to enable residue detection and characterization, logic and command operations execution and camera control, the computation means accumulating an on-line created wafer images and wafer residue defects data base, the computation means providing for inspection tool worthiness monitoring, wafer handling and transportation means. A method of automatic optical self-contained inspection for pattern wafers' polishing residue detection is also provided.

### CROSS REFERENCE TO RELATED APPLICATIONS

This application is a National Stage of International Application No. PCT/IL2005/001110, filed Oct. 26, 2005, and which claims the benefit of U.S. Provisional Patent Application No. 60/622,443, filed Oct. 26, 2004. The disclosure of the above applications are incorporated herein by reference.

### FIELD OF THE INVENTION

The present invention pertains in general to the semiconductor integrated circuits device manufacturing. More specifically, the present invention relates to wafers processing quality inspection and, in particular, to a method and apparatus for polishing residue detection and characterization, and polishing operation working order assessment.

### BACKGROUND OF THE INVENTION

Chemical-mechanical polishing (CMP) is a well-known process in the semiconductors manufacturing industry. It removes and planarizes metal, alloy and dielectric material layers deposited on wafer's surface. CMP typically involves mechanical polishing of the front surface of the semiconductor wafer by a pad soaked in chemical slurry, which contains abrasive components. The layers of non-desired deposited materials are supposed to be totally removed.

It often occurs, however, that not the entire metal layer is removed, due mostly to the process control impairments, such as pads fractional damage, thereby leaving a residue on the processed wafer. Generally the term residue refers to any material layer remains, the CMP should remove entirely.

The presence of a residue might impair the quality of the final product. The yield and productivity are adversely affected if the residue presence is not detected on time. Therefore, the polished wafers inspection for residue is widely implemented in semiconductors' manufacturing processes and procedures.

When the residue is detected on time, some successful correction actions, such as defected wafer re-processing, or defected wafer exclusion from consequent process flow, might take place. Close monitoring and awareness of the polishing tool operational quality and its maintenance initiation are attained as well.

The prior art indirect end-point polishing on-process technique implemented in numerous manufacturers' polishing tools for process control doesn't prevent processing residue events and the inspection for remains becomes a necessity.

Alas, the mostly used residue detection method is a polished wafers' visual manual inspection. This process is time-consuming and labor-intensive, human error prone and its off-process implementation interferes with the manufacture process flow, causing time, productivity and production floor area losses.

Automatic common type defects detection tools, augmented by machine vision means, are capable and, in certain cases, used for polishing residue detection, characterization and classification. One of the approaches known in the art is to detect the deviations of thickness of a homogeneous film stack, while treating the metal residue as a transparent film. This method and apparatus based upon it stipulate a-priory knowledge of numerous underlying stack parameters. They have limitations in heavily patterned wafers inspection, are off-process implemented and their inspection throughput rate is low.

The defects detection principle of a plentitude of prior art methods and instruments is based on per chip wafer inspection, employing the comparison either to “golden” wafer/chip image/mask, or by inter-chip comparison within a wafer-under-test. Other instruments implement learning processes of images or reflected spectra of flawless wafers to be compared to the ones of the wafer-under-test. A mandatory extensive and demanding process of recipes generation for the variety of each manufacturers patterned wafer topology and polishing tools specifics precedes the operational deployment of inspection/monitoring tools. These tools usually implement resolutions beyond the practically sufficient levels for viable residue detection. Commonly, only predetermined portions of wafer surface are actually tested for residue. When the prior art inspection encompasses the whole wafer's surface, the image is generated either piecewise or by scanning, and the illumination, accordingly, covers right away only a small portion of wafer's surface under test. Alternatively, complicated and bulky multi-beam parallel illumination and imaging principle are implemented in prior art apparatuses. Precise wafer alignment is commonly employed for accurate comparison/correlation execution, thus prohibiting on-process, in-situ, add-on implementation.

Some prior art methods utilize complicate illumination and imaging beam forming schemes, including optics and planar and spherical mirrors to encompass simultaneously entire wafer surface lighting without eclipse. The resulting implementation dimensions bar these prior art apparatuses to be add-on configured in the available constrained volume of the parent tool.

Still other prior art methods comprise combined multiple different wavelength and nature (bright field, dark field, polarized light) illumination schemes, providing means for multi-domain defects scattering and spectra characteristics analysis. The resulting apparatuses' dimensions exceed the constraints of the available space for on-process implementation. Some prior art schemes, incorporating diffracted light analysis, are ill suited for highly reflective metal residue discrimination on patterned wafer surface.

Certain prior art methods deal with surface inspection by contrast variation analysis. The apparatus based on this method is off-process implemented, employs instantaneous entire wafer imaging and illumination. This method objective and apparatus arrangements are the inspection of opaque, non-polished wafers, thus making them improper for residue detection, especially on patterned wafers, with inherent ample contrast variations.

A prior art method exists, implementing inspection for opaque homogeneous surfaces finishing defects detection by instantaneously encompassing the whole inspection scene area in a single frame. It utilizes duple surface images with displaced illumination source positioning to produce a difference image, which emphasizes the defects' contrast. This method is ill suited for patterned, transparent upper silicon layer wafers inspection aimed at tiny defects detection.

Some automatic visual inspection apparatus and method of prior art are employed directly into polishing process, and add-on implemented. The inspection covers only a small portion of the entire wafer at a time and is targeted to replace or complement the end-point polishing process control. This method is not suited to detect limited area residues, caused by polishing machine pad's surface fractional defects/malfunction.

Some of the prior art methods, in-situ integrated into polishing tool operation, necessitate the polishing tool alternations and modifications, and are suited mostly for non-patterned, pilot wafers inspection for “killer” particle defects detection.

Consequently, there is a need in the art for a method and apparatus permitting on-process almost in-situ seamless inspection for residue detection.

In particular, there is a need for an implementation method, utilizing the wafer handling and transportation mechanisms of the “parent” robot with minimum/no changes in its hardware, software and without operation cycle modifications. The parent tool of disclosed invention's preferred embodiment is the output load stage of the Ontrack DSS-200 washer/scrubber robot, which executes the indispensable back-end process of wafer planarization cycle.

A further need exists for a method and apparatus capable of detecting residues occupying even only a small portion of the wafer's surface.

There is a further need for a method and inspection apparatus implementation capable of entire wafer surface inspection amid the parent tool mechanical wafer transportation inherent non-accuracies and tolerances.

Furthermore, a self-contained inspection method is needed, without the stipulation either for “golden” wafers data stockpile accumulation, or complicated learning process involvement and recipes generation, or high-resolution and placement accuracy demanding intra-wafer inter-chip comparison. There is therefore a need for robust algorithms for discrimination between the Tungsten residue infested wafer surface portions and the rest, unspoiled patterned wafer surface, based solely on their scattering intensity and colour spectra characteristics.

There is still further need for a method and apparatus capable of fast execution of the imaging and computation tasks of the residue detection processes, to permit inspection processes incorporation in the parent tool production cycle timeframe. This need summons instantaneous or almost instantaneous wafer under test surface image acquisition principle, and accordingly entire wafer illumination simple means, being capable to fit into constrains of parent tool space, operation dynamics and cycle. As well, tailored, residue detection task oriented and optimized image processing manipulation algorithms are needed.

Furthermore, there is a need for detected residue metrology quantification and characterization and appropriate data base accumulation for consequent polishing tool integrity evaluation and preventive maintenance prompting.

There is an additional need for complementary continuous monitoring of inspection tool and its interface with parent tool operational worthiness and timely malfunctions alarm triggering.

### SUMMARY OF THE INVENTION

In accordance with the present invention there is provided an automatic optical inspection tool of an apparatus for residue detection on polished wafers, comprising an inspection tool, an illumination source, capable of instantaneous entire wafer surface illumination, colour digital camera, encompassing the entire wafers surface without eclipse, in a duple of consecutive, properly delayed imaging shots and providing appropriate image resolution for tiny residue detection, computation means, implementing image processing and manipulation algorithms to enable residue detection and characterization, logic and command operations execution, and camera control, said computation means accumulating an on-line created wafer images and wafer residue defects data base, said computation means providing for inspection tool worthiness monitoring, wafer handling and transportation means, and an operator for controlling inspection process and results supervision and on-time process flow alternation or interruption to efficiently and timely incorporate and carry out the inspection process findings and prompts.

The invention further provides a method of automatic optical self-contained inspection for pattern wafers' polishing residue detection with sub-pixel defect size effective spatial sensitivity, based on wafer-under-inspection surface light scattering colour-intensity computerized analysis, comprising the steps of setting-up initial calibration and correction data derivation, wafer image acquisition and rendering, lighting intensity and camera sensitivity colour spectra biases and spatial variances compensation, duple images registration and merging for full wafer surface inspection execution, self-contained image scattering intensity analysis for outstanding, amplitude and colour-ratio comparison based, residue-covered areas discriminating against the patterned wafer area portions, not containing polishing residue defects, and image rectification and inspection results on-screen presentation containing wafer-under-inspection zoomed image and corresponding emphasized detected residues image.

Optionally, the invention also provides an apparatus wherein the inspection tool is part of a parent tool provided with an interface for communicating therewith. Accordingly, the apparatus further comprises a parent tool wafer-handling and transportation means contained in an output stage robot, said inspection tool includes a support structure, mounted on a parent tool chassis, said computation means including an information exchange interface with a parent tool operator via computer screen, with process floor host, and with the parent tool electrical trigger module, and said parent tool operator executing the man-in-the-loop control functions.

### BRIEF DESCRIPTION OF THE DRAWINGS

The invention will now be described in connection with certain preferred embodiments with reference to the following illustrative figures, so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1a and 1b are side and front schematic views of the apparatus for carrying out one preferred application of the method, according to the present invention;

FIG. 2 is a timing diagram of image acquisition synchronization;

FIGS. 3a and 3b depict the two frames obtained in each wafer image acquisition;

FIGS. 4a and 4b illustrate the image registration (position) means and procedures;

FIGS. 5a and 5b illustrate the image scaling (zoom) means and procedures and the registration outcome;

FIGS. 6a and 6b depict the calibration fully Tungsten covered wafer image and one of the basic colour's luminance variations compensation images;

FIGS. 7a and 7b illustrate the non-shadowed wafer image and a merged image with blanked-out rim and marking areas;

FIG. 8 depicts the wafers area partition for different local detection intensity thresholds application;

FIG. 9 is a presentation of residue detection outcome image;

FIG. 10 represents the reflected light intensity histogram of patterned wafer with Tungsten remains;

FIG. 11 represents the Tungsten remains' colour ratio histograms;

FIG. 12 represents the colour ratio histograms of a portion of a patterned wafer surface, not containing Tungsten remains;

FIGS. 13a, 13b and 13c illustrate the corrected wafer and remains images and metrology results, as presented on the inspection tool screen;

FIG. 14 is a flow diagram, presenting various modes of the apparatus operation, according to the invention;

FIG. 15 is a flow diagram illustrating a calibration mode, and

FIG. 16 is a flow diagram illustrating the operational mode and its image processing functions.

### DETAILED DESCRIPTION OF THE PREFERRED EMBODIMENT

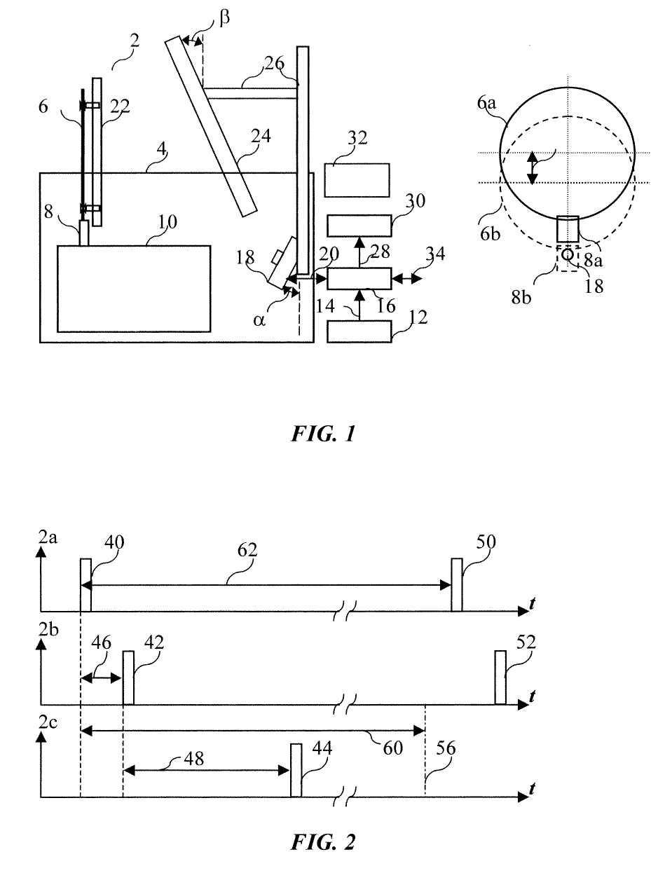

FIGS. 1a and 1b are schematic drawings of side (a) and front (b) projections of the present invention apparatus arrangement 2, mounted on a parent tool 4. The static FIG. 1a presentation corresponds to a certain moment in parent tool 4 robot dynamics, when a wafer 6 settles on download lifter 8 in its uppermost position, before descending to the output cassette 10. The electronic section 12 of the parent tool 4 then produces a trigger signal, which is fed through link 14 to the apparatus computer 16. The computer in turn triggers a camera 18 through link 20 after a necessary delay, when the utmost opening of robots arm's wafer grip 22 causes no line-of-sight obstruction from camera 18 to wafer 6. The inspection tool illumination source 24 and camera 18 are mounted on supporting structure 26, which is clamped to the chassis of the parent tool 4. The illumination source 24 and camera 18 are both inclined by about 30° angles α, β, respectively, relative to vertical (in opposite directions), thus providing for specimen surface bright-field illumination and encompassing by a single shot, and fitting into the parent tool space and robot dynamics constrains. The illumination source 24 dimensions are sufficient to produce rays of light, to be specularly reflected even from the wafer surface periphery, and consecutively captured by the camera 18. The camera 18 images are fed by link 20 to the computer 16, where image and data processing are executed. The inspection results are fed through link 28 to monitor screen 30 to be observed by production floor operator 32, responsible for parent's tool wafer lots loading-discharge and present invention inspection results and prompts supervision. When the link 34, transferring inspection data to/from host process controller is activated, most of the human operator's inspections tasks are overtaken by the host operation.

Wafer grip 22 partially occludes the light way from illumination source 24 to the wafer 6, thus producing shadowed areas in the resulting image. To achieve adequate entire wafer surface imaging, a second frame acquisition takes place.

FIG. 1b depicts two extracts of parent tool dynamics. Wafer 6a and lifter 8a positions match the ones depicted in FIG. 1a, when the first image acquisition takes place. Wafer 6b and lifter 8b positions correspond to a certain time lapse, when the arm grip departures completely from the imaging scene and the wafer travels down by distance 36 on its descends to output cassette. The additional frame image taken by camera 18, prompted by a second delayed trigger produced by computer 16, complements the first image's shadowed areas.

FIG. 2 depicts the timing diagrams of image acquisition synchronization with the parent tool operational dynamics cycle. Electrical signal 40, originated in the electronic section 12, prompts computer 16 to produce two delayed signals 42, 44. These signals trigger the camera 18 to obtain two images, comprising full wafer surface coverage. The delays values 46, 48 are set in the preferred embodiment to 1400 msec and 4000 msec correspondingly, and are adjustable for other present invention embodiments. Signals 50, 52 represent follow-on operational cycle's parent tool and camera-delayed triggers signals correspondingly. Dashed line 56 indicates the inspection tool operational cycle of duration 60 completion moment, prior to the expiration of the parent's tool cycle of duration 62.

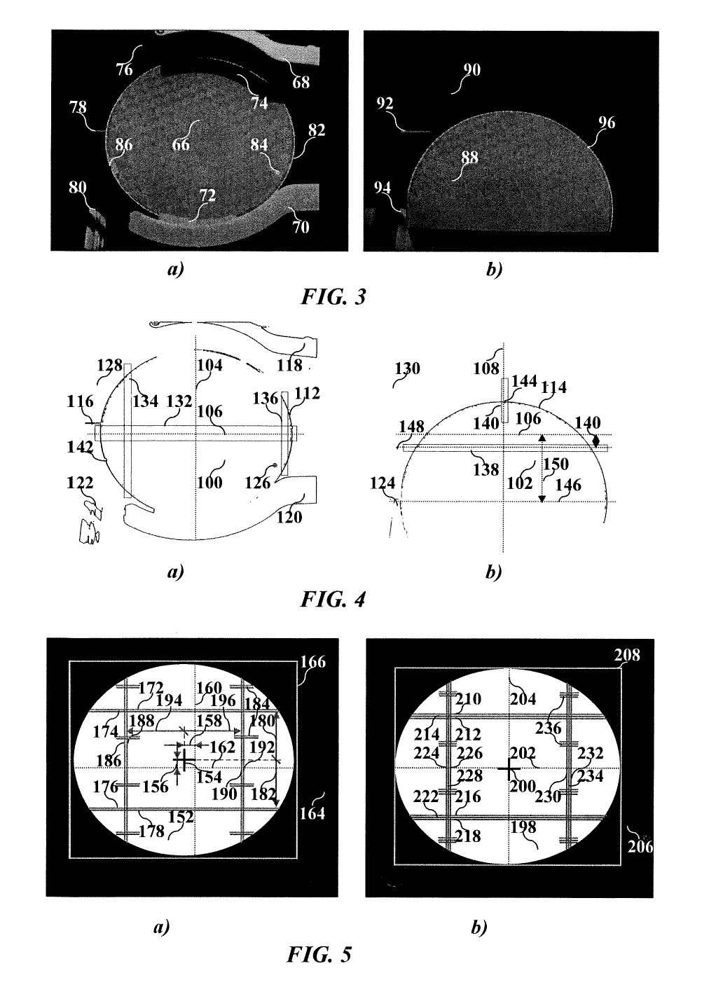

FIG. 3a depicts the wafer under inspection first scene image, taken at delay 46, while FIG. 3b depicts the second scene image of the same wafer under inspection, taken at a delay 48. Both are grey scale presentation of original colour RGB camera pictures. 66 depicts a mildly patterned wafer, positioned around the scene frame's centre. 68 and 70 represent the upper and lower sections of robot arm's wafer grip 22, while 72 corresponds to a portion of lifter 8. 74 is the shadowed part of wafer's image 66, produces by the upper portion 68 of the grip 22, causing illumination obstruction. 76 is predominantly dark scene's background, while 78 represents a production space's light bulb, contained within the imaging scene, and appearing adjacent to the contour of wafer image 66. Item 80 depicts an illuminated portion of parent tool's internal structure contained in the imaging scene. 82 indicates the bright contour of the wafers image at the outer rim, caused by wafer edge reflections. 84 depicts the minute Tungsten residue reflections, appearing brighter than the surrounding patterned wafer's scattering. Item 86 points to wafer notch and marking areas.

Item 88 of FIG. 3b is the wafer appearance in the second delayed frame. The wafer image's lower part is clipped by the picture's frame, and another adjacent lower portion of the image is under-illuminated. Nevertheless, the previously shadowed portion 74 of wafer image 66 is fully illuminated now, thus providing for full surface analysis for remains. 90 stands for wafer image's background, 92 for straw light bulb image, 94 for an illuminated portion of parent tool structure and 96 for the bright outer rim wafer contour, as they appear in the second picture frame. The wafer-related images 66, 88 show up as ellipses, and not circles, due to the camera 18 inclination angle α. During the second frame acquisition, the descending wafer is physically closer to the camera 18 and its image 88 ellipse becomes greater than the ellipse 66 of the first frame.

FIGS. 4a and 4b illustrate and clarify the acquired duple frame images registration means, procedures and purpose. Image registration of the invention's preferred embodiment is intended to facilitate flawless entire wafer surface inspection, in spite of substantial inter-tool and intra-tool (wafer-to-wafer) tolerances of the parent tool output robot moving parts' relative positioning, motion speeds and trigger in-accuracies. Additionally, the cross-registration of the first and second frame images is essential to precisely recover the partial shadowing of the first image. The duple wafer images 100, 102 positioning relative to the frame centre (dashed lines 104, 106, 108, 146, image frame symmetry vertical and horizontal axes intercept point) and wafer image sizes, both deviate from tool-to-tool and from frame-to-frame. Initial inspection tool position calibration to be disclosed below, takes care of the bias (DC) portion of these image position and size changes (tool-to-tool). The deviation's variance (AC) portion compensation is the operational registration process aim. The wafer's bright outer rim 82, 96 location knowledge-based flawless exclusion from analysis for residue detection, and therefore, false alarms avoidance is accomplished as a consequence of images precise registration.

FIGS. 4a and 4b present the intensity-inverted outcome of the well known in the art of image processing Edge Detection (ED) and brightness threshold (binarization) algorithms, applied in succession onto the Blue part of standard RGB images presented in FIG. 3. The well-known art of Sobel ED, threshold and standard RGB colours separation algorithms are utilized. The selection of the Blue part of wafer scene's colour image maximizes the brightness difference between the wafer's 66, 88 rim contour image 82, 96 containing predominantly white colour bright scattering points, and interfering yellow-coloured images of light bulbs 78, 92 of semiconductor manufacturing floor environment. The wafer rim contour 112, 114 is emphasized in the binarized images (FIGS. 4a, 4b), when compared to the light bulb corresponding trace 116. The second frame's bulb trace in the image of FIG. 4b, is below the binarization level and does not show up at all. The robot arm's wafer grip contours 118, 120 and parent tool internal parts contours 122, 124 still interfere with the wafer contour 112, 114. 142 indicates the wafer notch position in the image frame, 126, namely, the Tungsten residue appearance. The apparent ease of residue 126 discrimination task, as invoked by the image's content (FIG. 4a), is due to a relatively low level of wafer 66 pattern contrasts. In general, this is not the case for heavily patterned wafers. Background 128, 130 does not contain bright contrasting objects, and thus, does not interfere with wafer contour location task. The wafer registration is accomplished by finding wafer image rim ellipse's centre coordinates XC, YC and semi-axes sizes BA and SA. The first image's horizontal position and size determination virtual rectangular “window” 132, as well as other computational position and size determination windows 134, 136, 138, 140 are depicted as superimposed on the binarized image scene to illustrate the registration process mechanization. These windows are utilized to segregate (mask) certain portions of the image scene, containing registration pertaining data.

Window 132 is located symmetrically relative to the first image frame horizontal 106 and vertical 104 axes. According to the present invention, its width reaches out at least 30 pixels from each side of the nominal calibrated wafer ellipse horizontal axis edges, thus incorporating the maximum expected range of position and zoom divergences. The window height is 43 pixels, thus incorporating 43 parallel horizontal strings with running index i=1 to 43. This pixels' amount exceeds substantially the wafer notch's and light bulb's traces combined vertical dimensions. For each window's string the least left and most right horizontal position coordinates XLi and XRi of pixels above the binarization threshold (predominantly comprising wafer contour), are found. For each string, horizontal ellipse centre XCi coordinate and big semi-axis BAi size are calculated:

$$XCi = \frac{XRi + XLi}{2} ; BAi = \frac{XRi - XLi}{2} ;$$

Then the first iteration's average value XC and standard deviation value X̅C̅ of the above-found centre positions vector XCi calculation follows:

$$\overline{X} \overline{C} = \frac{{\sum }_{i}^{ } XCi}{43} ; = \frac{{\sum }_{i}^{ } {( XCi - \overline{X} \overline{C} )}^{2}}{42}$$

If [symbol] >1, the string's i, for which the difference |XCi− X̅C̅| is found to be maximum of all the strings, data is excluded from the follow-on calculation iteration, this time with i−1 strings involved. The loop calculations terminate when [symbol] ≦1 condition is met, where j is the overall number of iterations executed. The image ellipse horizontal centre coordinate XC is considered equal to the loop last output value X̅C̅j.

The resulting value of horizontal ellipse's semi-axis size BA is the maximal value of BAij between the final iteration's remaining strings BAj values.

If the calculus does not converge after 15 loops executions, the XC and BA values are borrowed from the previous wafer in lot position-related calculations, or, for the first wafer in lot case, set from the prerequisite parameters look-up table, obtained during calibration of the inspection tool. Wafer inspection for residue is executed nevertheless. Apposite colour marking appears on the corresponding wafer thumbnail, presented on the screen 30. An integrity flaw-warning signal is sent to the process operator 32 through the screen 30, and through the link 34, to the host. The warning prompts the operator to check visually the inspection results for the specific wafer. Tool integrity monitoring events intra-lot counter is activated, and when reaching a certain number, prompts a manual tool set-up check for registration failure cause detection. Similar inspection and parent tool worthiness monitoring-related Man-Machine-Interface (MMI) actions are performed on additional occasions, when the calculated XC and BA values differ from their expected values for more than a certain amount of wafers in a lot. A prompt for calibration execution or manual set-up check follows.

Similar calculation procedures are implemented for Left 134 and Right 136 Vertical masking windows. Two wafer ellipse image's 100 vertical centers YCl and YCr are found. These windows are located non-symmetrically around the frame's vertical axis 104 to avoid wafer rim's contour 112 missing portions inclusion (FIG. 4a). Windows' vertical extends are not equal in order to fit between the robot arm wafer grips contours 118, 120. The window's width is set at 27 pixels, i.e., each comprises 27 vertical masking strings. Each window's upper-least and down-most vertical coordinates of wafer image rim contour pixels are found. If necessary, YCli and/or YCri standard deviation convergence loop-wise execution follows, omitting outstanding values strings data. Resulting YCl and YCr and their equilibrium YC (weighted by corresponding windows distance from vertical axis), are calculated. As well, for each modified vertical window 4 sets of x, y coordinates of windows corner points are noted. These sets are utilized to find 8 values of wafer ellipse small semi-axis values, based on ellipse equation:

$${SAL}_{k} = \frac{{yl}_{k} - Ycl}{\sqrt{1 - {( \frac{{xl}_{k} - Xc}{BA} )}^{2}}} ; {SAR}_{k} = \frac{y {r}_{k} - Ycr}{\sqrt{1 - {( \frac{{xr}_{k} - Xc}{BA} )}^{2}}} ,$$

where k=1 to 4

The obtained SALₖ and SARₖ values are sorted, and their extreme values (the most and the least) omitted. Then an arithmetic average SA of the remaining six values, is calculated.

The vertical 140 and horizontal 138 masking windows of FIG. 4b serve the duple frame wafer images, cross-registration execution. Window 140 is located symmetrically around the frame's vertical axis 108. The vertical length covers (with some safety shoulders) the second frame's wafer ellipse rim contour 114 at the apex 144 vertical position region, corresponding to wafer descent amount 150. The descent amount is defined as the difference between the vertical coordinates of the first frame wafers ellipse horizontal axis 106 and the second frame wafers ellipse horizontal axis 146. The wafer rim apex point position 144 is found as the least vertical coordinate of image scene (wafer's binarized contour), masked by window 140 strings. The second frame's wafer ellipse parameters YC2 (vertical centre position), BA2, SA2 (axes sizes) are found from a look-up-table (LUT), containing these parameters values corresponding to each one of possible apex point 144 vertical position values. The second image ellipse horizontal center position XC2 value is found utilizing window 138, which horizontal symmetry axis 148 vertical positioning 110 (distance from the first frame's horizontal axis 106 vertical position) is predetermined. The XC2−XC and Ycl−YCr differences' values and signs contain parent tool robot lifter's inclination amount and direction-related information. These values, as well as the YCli, YCri standard deviation non-convergence event flag, enter the inspection and parent tools worthiness monitoring procedures logic processing, resulting in appropriate messages and warnings on screen 30 and to the host. This worthiness information is important for timely prevention of excessive lifter inclination-caused wafer damage on descend to the cassette.

The found duple frames ellipse's parameters are utilized for accurate images registration, as depicted in FIGS. 5a and 5b.

FIG. 5a presents a simulated first frame wafer ellipse 152 pre-registered image. The ellipse centre 154 (cross) is displaced by horizontal amount 158 and vertical amount 156 and from frame's symmetry vertical axis 160 and horizontal axis 162, correspondingly. Item 164 represents the simulated frame black background. The actual pre-registered wafer ellipse axes are smaller than their nominal values. It is made apparent by superimposing a virtual rectangle 166 image with sides dimensions equal to the nominal wafer's ellipse axes sizes and displaced from frame centre by the same biases 156 and 158, the wafer ellipse image 152 is displaced:

156=YC−YCn; 158=XC−XCn,

where

XCn and YCn are the frame centre position horizontal and vertical indexes, and YC and XC definitions are disclosed in FIGS. 4a and 4b described above.

The zooming (in or out) is performed by image lines and columns padding/decimation fittingly. This zooming technique, in contrast to the commonly used image scaling interpolation practice, is computationally un-assuming and does not alter the original images pixel's intensity and colour ratio values. The small amount of rows and columns to add or remove allows for this task execution without perceptibly impairing the wafer's image outer rim continuity. Original image geometry change does not affect the residue detection, based solely on intensity and colour characteristics. In the case as presented in FIG. 5a, rows and columns padding is accomplished. The amount of padding rows/columns is found:

ΔCo=(BAn−BA)*kc; ΔRo=(SAn−SA)*kr,

where ΔCo is the amount of columns to add or remove, according to sign;

BAn is the nominal big semi-axis size;

BA is the actual big semi-axis size of pre-registered image;

kc stands for the ratio between frame images horizontal pixels count, and BAn.

ΔRo is the amount of rows to add (remove);

SAn is the nominal small semi-axis size;

SA is the actual small semi-axis size of pre-registered image;

kr stands for the ratio between frame images vertical pixels count and SAn.

In practice, Δco and ΔRo are limited to −10 to +10 values range.

First, the vertical positions of rows to add/remove and the horizontal positions of columns to add/remove are determined. The candidate padding/decimation positions are symmetrically laid out around the ellipse centre position 154. The actual ΔCo, ΔRo values are rounded up to the closest even value. If padding is to be performed, a pair of adjacent columns/rows at every padding position is noted. Items 172, 174 and 176, 178 represent such two rows pairs, placed equidistantly from ellipse centre (180=182). Item 184 represents the traces of two additional rows pairs out of overall 8 rows of padding in the image. Items 186, 188 and 190, 192 represent such two column pairs, placed equidistantly from ellipse centre (194=196). For each pair of selected for padding rows and columns, an additional intermediate row and column pixels intensity values are calculated as an arithmetic average of adjacent pixels intensities in the original pair.

For example:

172_{—}4ₓ=(172ₓ+174ₓ)*0.5; 186_{—}8_{y}=(186_{y}+188_{y})*0.5,

where 172_{—}4ₓ is the padding row (to be placed in between rows 172, 174) pixel's intensity values (calculated separately for each basic colour), and

186_8_{y} is the padding column (to be placed in between columns 186, 188) pixels intensity values (all 3 colours).

FIG. 5b depicts the corrected wafer's image. Original image shifting by calculated amounts (−156) and (−158) vertically and horizontally takes the wafer's image 198 centre cross 200 to the frame central point (intersection of axes 202, 204) with coordinates Xcn, Ycn. Item 206 stand for scene background depiction; item 208 is the virtual rectangular frame indicating the nominal wafer ellipse image size. The zooming procedure increases the original wafer's image, making it tangential to the rectangle sides. A trio of rows and columns replaces the image's FIG. 4a corresponding rows and columns pairs at the predefined padding positions. Thus, row 210 corresponds to row 172, row 212 to row 174 and row 214 contains the calculated above row's 172_4ₓ values. Similarly, row 216 corresponds to row 176, row 218 to row 178 and row 222 is a vector extrapolated from rows 176 and 178 adjacent values. In the same manner, column 224 corresponds to column 186, column 226 to column 188 and column 228 is the calculated above column 186_8_{y}. Similarly, column 230 corresponds to column 190; column 232 to column 192 and column 234 is a vector extrapolated from columns 190 and 192 adjacent values. The same is pertinent for rows trios 236, corresponding to pairs of rows traces 184.

The case of decimation (zooming out) might be illustrated in the inverse way: now for every trio of symmetrically laid out columns and/or rows, as in FIG. 4b, a replacement pair of columns/rows is created. The pair vectors pixels intensity values are set by selecting the maximum values of every two adjacent vectors pixels values of the “original” trio. This procedure is beneficial for successful residue detection, preserving the strong intensity values (potential residue) in spite of the partial decimation of the original image intensities distribution content.

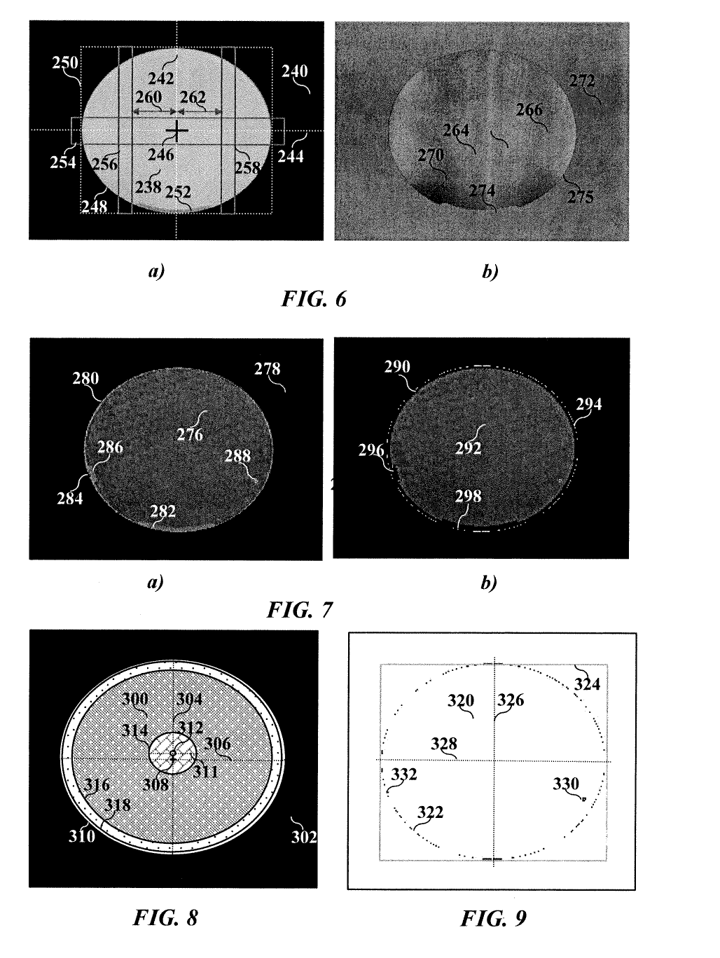

FIGS. 6a and 6b illustrate the calibration process procedures and data derivation to be used for images compensation in the operational mode. The calibration is contained in the initial inspection tool installation procedure, and is executed at follow-on parent tool maintenance events, as well. Also, calibration is initiated following decision prompts originated by the present invention parent and inspection tools' worthiness monitoring. Fully Tungsten covered wafer placed on the lifter 8 in its uppermost position is used for calibration.

Item 238 of FIG. 6a represents the fully covered wafer image's colour-to-grey conversion (CtGC) results. The conversion type utilized in the current invention, operating on a pixel by pixel of the same denomination x,y basis is:

$${GREYcal}_{x , y} = \frac{{Rcal}_{x , y} + {Gcal}_{x , y} + {Bcal}_{x , y}}{3} ,$$

where GREYcal_{x,y} stands for grey level intensity of a calibration image pixel with coordinates x, y, and

Rcal_{x,y}, Gcal_{x,y}, Bcal_{x,y} are Red, Green and Blue components of the same pixel's calibration wafer colour image.

The fully Tungsten covered wafer images grey intensity values dispersion is small, when compared to patterned wafer intensities distribution. The reasons and benefits of utilizing this specific conversion known in the art, is disclosed further.

Item 240 represents the simulated black background. Items 242, 244 depict the image frame axes, and frame centre is 246. Item 248 is wafer rim, and 250—a virtual rectangle with sides dimensions equal to the nominal wafer ellipse axes sizes. 252 is the lifter portion image, enclosed within the wafer contour.

The wafer calibration image registration procedure is similar to the one executed on operational wafers and described in FIGS. 4a, 4b, 5a and 5b. The original image intensities itself are binarized, instead of their edge detection outcome, as in FIG. 4. Item 254 is the horizontal masking window, placed around the frame's horizontal axis. 256 and 258 are the vertical windows, placed symmetrically around frame's vertical axis (260=262). The calibration images shooting scene does not contain parent tool output robot arm wafer grips. The calibration registration process concludes in LUT correction values derivation, to be used in operation mode for images position and size deviation compensations caused by tool-to-tool and inspection tool mechanical interface (drift) changes.

Wafer image ellipse mask matrix M_{x,y} is generated as well, utilizing the ellipse equation and found calibration image centre position and semi-axes sizes.

If the calibration image intermediate size values exceed predetermined wafer ellipse size limits, automatic camera 18 zoom adjustment is stepwise executed, driven by computer 16 derived controls via camera link 20. In each iteration step, additional intermediate calibration image is created, until the wafer image ellipse size falls into predetermined tolerance range. In excessive image position offset case, the system prompts the camera 18 position manual adjustments.

Illumination level calibration is accomplished by the wafers' ellipse image greyscale intensity averaging:

IL=mean(GREYcal_{x,y}∩M_{x,y}); ΔIL=IL−IIn,

where IL is the averaged greyscale wafer image ellipse intensity;

GREYcal_{x,y} is the greyscale calibration wafer image matrix intensity values;

ΔIL is illumination correction bias, and

IIn is the nominal illumination intensity value.

If the found intermediate ΔIL value exceeds predetermined tolerance region values, automatic stepwise camera 18 aperture (exposure) adaptation is performed, controlled by computer 16 via camera link 20. At each iteration, an additional calibration wafer image is created, and the process terminates when ΔIL value falls into a predetermined tolerance range.

The calibration colour image is utilized as a reference for initial camera 18 White Balance (WB) setting, thus assuming that the fully Tungsten covered wafer image colour is white, and basic colours' intensity ratios are close to 1, when averaged over wafer front surface area.

During operational wafers inspection, the above calibration-derived values and data matrices allow for reflected light intensity spatial variance equalization. This equalization compensates for:

(i) Illumination source 24 inter-colour and spatial intensity non-uniformity;

(ii) Distance differences between light rays that are emanated from the illumination source 24 surface, scattered by the wafer surface to make their way to the camera 18 lens;

(iii) Camera 18 pixels sensitivity inter-colour (WB) and spatial non-uniformity.

The compensation is mechanized according to the following equations, where the operations on images different colour matrices is done on pixels by pixel of the same denomination x,y basis:

$${Rcomp}_{x , y} = ( \frac{{Rop}_{x , y}}{{Rcal}_{x , y}} ) * I ln ; {Gcomp}_{x , y} = ( \frac{{Gop}_{x , y}}{{Gcal}_{x , y}} ) * I ln ;$$

$${Bcomp}_{x , y} = ( \frac{{Bop}_{x , y}}{{Bcal}_{x , y}} ) * I ln ;$$

$${GRAYcomp}_{x , y} = \frac{{Rcomp}_{x , y} + {Gcomp}_{x , y} + {Bcomp}_{x , y}}{3}$$

where Rop_{x,y}; Gop_{x,y} and Bop_{x,y} are the Red, Green and Blue components of the operational image matrix pixels intensity values before compensation;

Rcal_{x,y}; Gcal_{x,y} and Bcal_{x,y} are the Red, Green and Blue components of the calibration image matrix pixels intensity values;

Rcomp_{x,y}; Gcomp_{x,y}, Bcomp_{x,y} and GREYcomp_{x,y} are the Red, Green, Blue and greyscale components of the operational image matrix pixels compensated intensity values, and

IIn is the nominal illumination intensity value.

FIG. 6b depicts, with intentionally enlarged contrast, the intensity image grey scale appearance of one of the calibration image colour matrices Rcal_{x,y}; Gcal_{x,y}, Bcal_{x,y}, used to equalize the operational image spatial intensity on a per pixel level.

The image 264 pixels intensity variations are clearly distinguishable. Item 266 points to a dark vertical strip, 268 to a bright one. 270 is a predominantly darker region. 275 indicates wafer rim. The background 272 and excluded lifter area 274 intensity compensation matrix pixels' values are set at “0” value.

The calibration process generates and tabulates, inter alia, the following geometrical correction and intensity compensation values and data:

(i) ΔX, ΔY—image centre horizontal and vertical shifts.

(ii) ΔCo, ΔRo—number of columns and rows to be added/removed for ellipse size normalization.

(iii) Rcal_{x,y}, Gcal_{x,y}, Bcal_{x,y}—calibration image separate colours pixels intensity matrices, to be utilized for corresponding colour operational image intensity matrix's pixels intensity compensation.

FIG. 7a illustrates the duple wafer images merging result 276. Masking (logic AND operation on intensity values) by mask M_{x,y} causes the background 278 becoming exclusively black. Merging eliminates the previously shadowed area in the upper-right portion of the first frame image. The merging operation follows second frame image's registration and scaling to the frame-registered first frame image and logic OR execution on their equal coordinates' pixels intensity values. 280 points to wafer image bright rim, 282 is a portion of lifter image; 284 stands for wafer notch, 286 for marking area adjacent to wafer notch. 288 points to Tungsten residue-occupied wafer area. The metal residue specular reflection nature makes it brighter than the rest of the patterned wafer surface where some diffusion of reflections occurs.

FIG. 7b illustrates the exclusion of bright wafer areas interfering with residue detection. Wafer rim adjacent area 290 at the periphery of the wafer image 292 is blackened by masking the wafer image by a mask ellipse MR_{x,y} with semi-axes BA_{MR}, SA_{MR}, calculated as:

BA_{MR}=BA_{M}−Ph; SA_{MR}=SA_{M}−Ph,

where BA_{M}, SA_{M}—ellipse M_{x,y} semi-axis, and

Ph—wafer's periphery exclusion width, containing rim bright reflection pixels.

Wafer mage's border (rim) position is indicated by superimposed trace 294. Item 296 is the excluded wafer marking area, 298—excluded lifter image portion.

FIG. 8 depicts the division of the merged image 300 into five ellipse-shaped areas. The division allows the application of different level intensity thresholds for Tungsten residue detection separately in each created area, to deal with the scattering intensity local mean and variance gradual change from wafer image centre to periphery. Thus, spatially controlled Constant False Alarm Rate (CFAR) is achieved, enhancing the detection sensitivity. 302 represents the blackened background. Items 304 and 306 are frame symmetry axes. Cross 308 represents wafer image ellipse center. 310 points to wafer rim, 311 indicates the imaged wafer's actual center vertical displacement from ellipse center due to camera inclination. 312 is the central separation area, mostly prone to few pixels-size residue events. The second area's contour ellipse 314 center is at the actual wafer centre point. The third and fourth 316 and 318 areas' contour ellipses centres coincide with the frame centre 308. The area between ellipse contours 310 and 318 is the rim exclusion zone. The division is executed on registered merged operational wafer images, thus keeping constant values of the division ellipses contours' centres and semi-axes.

FIG. 9 depicts the residue detection results (inverted image, where black colour represents high intensity). Wafer image 320 size is marked by superimposed rim trace 322 and image size indicating rectangle 324. 326 and 328 are frame axes. 330 points to detected Tungsten residue and 332 to the notch point.

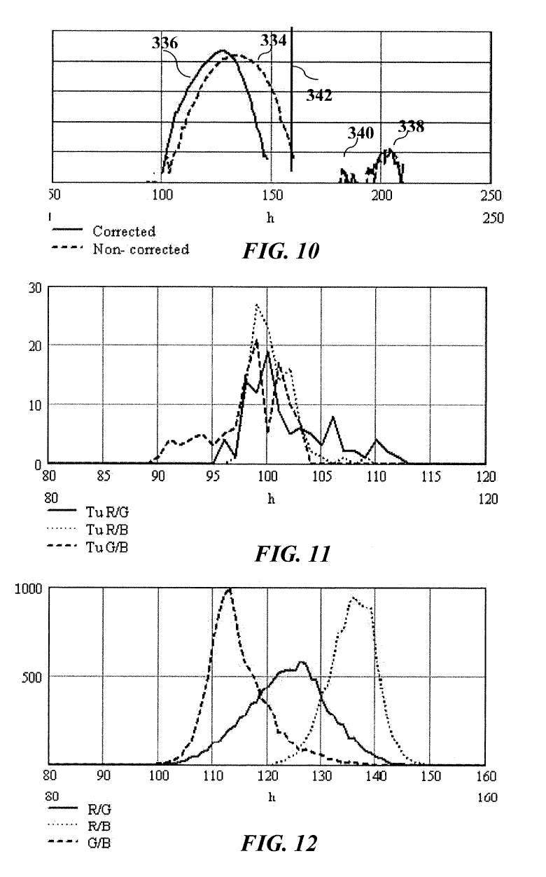

FIG. 10 depicts the patterned wafer scattering intensity histograms and illustrates the detection process. 334 and 336 are the histograms portions representing CtGC intensity levels distribution of patterned wafer image.

334 corresponds to a intensity histogram, calculated for well-known in the art vision-oriented CtGC scheme:

Grᵥᵢₛᵢₒₙ=0.587G+0.299R+0.114B

and does not employ intensity variations compensation. Item 336, to the contrary, employs equal colour contribution CtGC as disclosed in FIG. 6a description above, and image intensity variations compensation, both utilized in this invention. Almost identical 338 and 340 items depict the two CtGC schemes application results on the Tungsten residue-related pixels of the wafer image. Significantly narrower intensity levels distribution and lower maximum vales are noticeable for trace 336 when compared to 334 trace. The difference between Tungsten residue related traces 338 and 340 is rather small. Therefore, the employed CtGC and image intensity variations compensation allow for lower level detection intensity threshold 342 implementation, enhancing sensitivity without harming the false detection rate.

FIG. 11 depicts the colour intensity ratios (R_{x,y}/G_{x,y})*100; (R_{x,y}/B_{x,y})*100; (G_{x,y}/B_{x,y})*100 histograms for the Tungsten residue related pixels of wafer image. All 3 colour ratios histogram traces are centered around 100 (1) value (indicative of white-coloured Tungsten residue presence), and their variations do not exceed ±10% from their median value.

FIG. 12 depicts the colour intensity ratios histograms for the regular, not impaired area of a patterned wafer image. All 3 colour ratios histogram levels reach beyond 100 (1) value and the R_{x,y}/B_{x,y} ratio range is above the Tungsten-related colour intensity ratios ranges. This kind of colour ratios ranges non-overlapping distribution for Tungsten-occupied versus the rest of wafer areas complements and enables robust verification of the greyscale intensity-based detection.

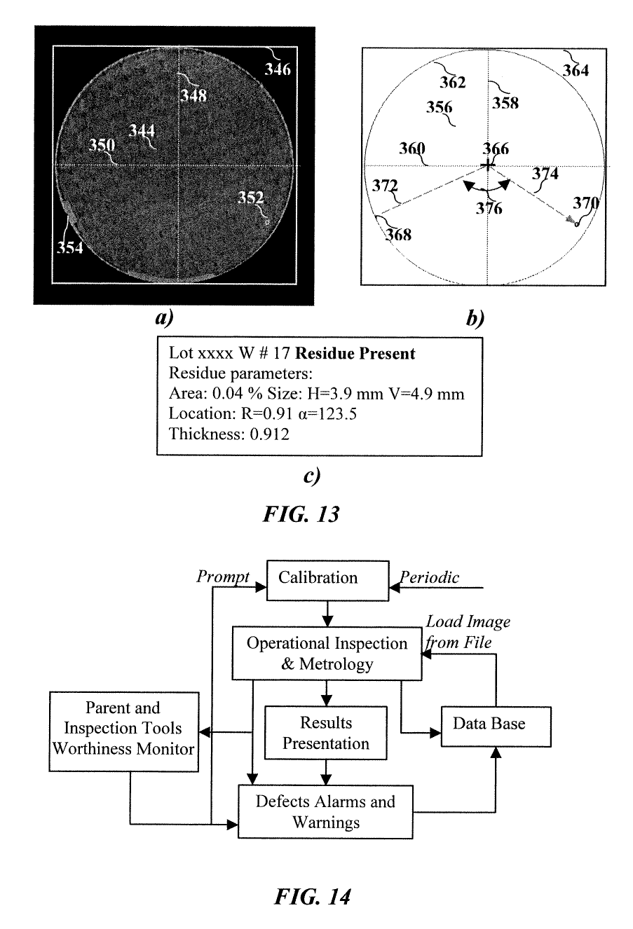

FIGS. 13a, 13b and 13c relate to inspection results presentation on system monitor screen 30.

FIG. 13a presents the rectified circular wafer 344 image. The operator 32 observes a natural circular appearance of the wafer image on screen 30, instead of the ellipsoidal shape of the original wafer image, caused by camera 18 incline. The perspective transformation (rectification) procedures, as described in referenced William K. Pratt, Digital Image Processing, pages 386-389 are incorporated herein by precedence. The superimposed wafer image size-embracing rectangle 346 becomes square. The background is black due to masking by mask M_{x,y} prior to rectification. 348 and 350 are rectified frame's axes. 352 is the Tungsten residue area. Item 354 is the notch area.

FIG. 13b depicts the Tungsten residue detection results corrected image. The image is intensity-inverted (negative) to accentuate the residue-related pixels presentation. Wafer image 356 size and location are indicated by superimposed axes 358, 360, rim trace 362, wafer size embracing square 364, frame center cross 366, notch position 368 images. 370 is the detected residue area. Superimposed lines 372, 374, connecting frame center point to notch and residue area center points are shown to illustrate Residue location polar coordinates definitions-scalar 374 and angle 376.

FIG. 13c represents the residue parameters characterization-metrology results, as reported on screen or/and contained in data transferred to host. The residue occupied area measure is normalized—related to the entire wafer image area. The polar coordinates of residue location definition are illustrated in FIG. 13b. The residue vertical size is defined by calculating the difference of the upper-least and bottom-most coordinates of the residue-related pixels. The residue horizontal size is calculated noting the left-least and right-most horizontal coordinates of residue related pixels. The residue thickness measure is defined by the averaged residue-related greyscale pixels intensity ratio to the ILn-nominal Tungsten intensity level. The parent and inspection tools worthiness monitoring information, prompt and alarm, messages appear on screen 30 and are reported to host, when relevant.

FIG. 14 depicts the present invention inspection tool states and modes diagram. The calibration is performed periodically and on prompted occasions. The tool normal continuous inspection operation culminates in residue presence detection, defects metrology, defects presentation—to the human operator by warning and alarms on screen, and to the host by transferred data content. In the background, the parent and inspection tools' worthiness is monitored, activating alarms and warnings when the system is out of tune, and/or when the automatic inspection results integrity is in reasonable doubt (as concluded by internal automatic procedures) and should be supervised by the operator. The acquired wafers images and defects detection images and metrology results comprise on-line real time created Data Base content. The events log-book data, concerning worthiness monitoring and wafer and lots flow information is saved in Data Base, as well. Load image from file mode allows for off-line Data Base saved images and performance analysis, enabling performance enhancement by algorithms adjustment.

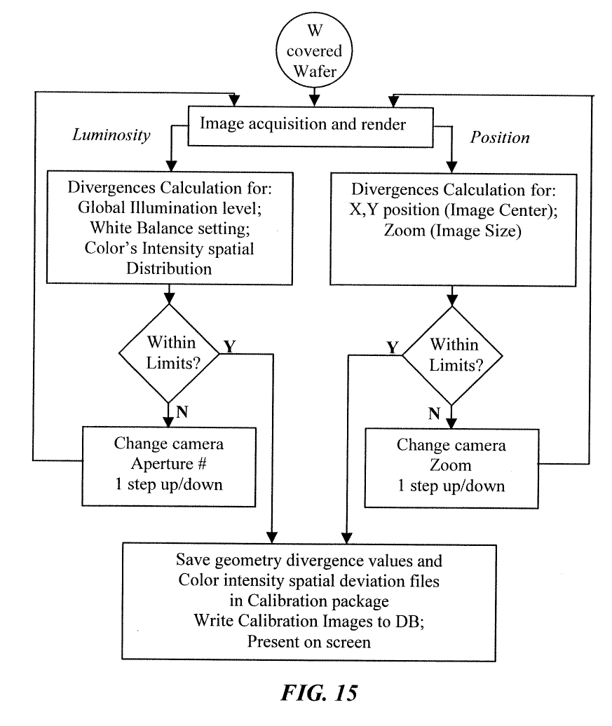

FIG. 15 depicts the present invention calibration process flow-chart. The fully Tungsten covered wafer images serve for inspection and parent tools position and luminosity-related parameters derivation and correction, rectification, intensity equalize data package creation. The package contains the global illumination bias, colour's spatial variance correction intensity matrices, position biases; image size (zoom) residual compensation data. While performing the calibration, automatically prompted and executed camera 18 aperture (exposure) and zoom settings are changed. The changes are made stepwise, and the loops operation terminates when divergences from luminance and zoom desired values is below predetermined levels. The calibration procedure ceases, while saving the outcomes data package for compensation of operational images.

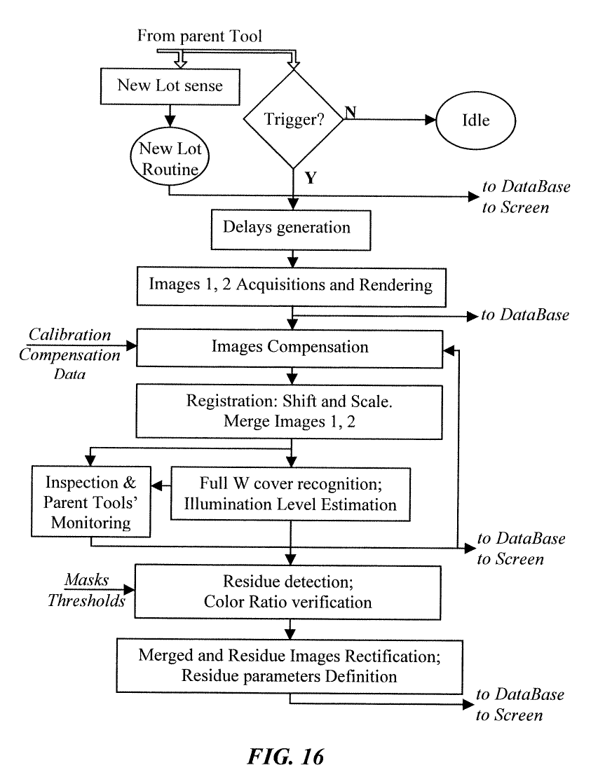

FIG. 16 depicts the present invention operational states flow-chart. The inspection tool cycle operation starts with parent tool originated trigger arrival. Necessary delays for first and second frame images triggering are generated. Acquired and rendered wafer images are saved in the data base and undergo compensation by calibration bundle biases for position and luminance intensity corrections. Each consecutive image registration follows, resulting in duple images merging to provide full wafer surface inspection coverage. The registration derived image geometrical transformations values and data are feed to the parent and inspection tool and their interface worthiness monitoring routine, implemented in the tool computer 16. For each merged wafer image under test, surface luminance averaged level and spatial standard deviation are calculated, and when certain quantitative conditions are fulfilled, fully tungsten covered wafer inspection event is recognized. This wafer's measured global luminance level is fed to the worthiness monitor as well, for the illumination source brightness and wafer positioning for imaging worthiness on-process assessment. The monitoring logical operations outcome is saved in the data base and presented on screen for operator awareness. The compensated wafer images undergo scattering intensity evaluation for Tungsten residue detection, utilizing the prerequisite threshold values and region separation masks. Colour ratios-based detections verification takes place, and if residue detection prevails, the rectified detection image appears on tool screen, amid the rectified wafer image for correlation and residue characterization metrology data presentation. The detection outcome results are recorded in the data base, as well. The MMI information presented on screen contains coloured thumbnails, corresponding to all already inspected current lot wafers before the wafer-under-inspection processing completion. The thumbnail colour code indicates residue presence or absence, and tools operational worthiness disturbance events. When browsing through the thumbnails, the operator is capable to supervise the automatic tool inspection outcomes by visually inspecting every chosen wafer and corresponding residue detection results image on screen. When the parent tool input cassette is replaced, an appropriate signal triggers off new lot routine initiation, causing accumulated screen thumbnails reset and new lot wafers count.

In summary, there has been disclosed an improved method and apparatus for automatic polished wafers inspection for residue. In the approach, an on-process add-on, almost in-situ (dry) apparatus implementation is disclosed. In the preferred embodiment, the invention apparatus is mounted on and integrated with “parent” tool, Ontrack's DSS-200 washer, scrubber's wafer handling and transportation means of the output robot stage. The methods employed allow for non-interrupted process flow, full wafer front surface coverage by inspection, 100% of wafers in production (not sampling) inspection, almost 100% inspection for residue success rate, low false alarm rate, inspection tool and parent tool operational worthiness monitoring and handy, fast and efficient man-in-the-loop incorporation for the automatic inspection process results supervision and process flow alternations initiation, like directing defected wafers for rework, polishing, parent and inspection tools malfunction repair, and others. These actions are driven and prompted by automatic inspection and monitoring results outcomes.

While the subject of the invention was described with reference to the preferred embodiment, various changes and modifications could be made therein, by one skilled in the art, without varying from the scope and spirit of the subject invention as defined by the appended claims.

What is claimed is:

1. An automatic optical inspection tool of an apparatus for residue detection on polished wafer surface, comprising:
an illumination source disposed at an angle to said surface, and capable of instantaneous illumination of the entire wafer surface;
colour digital camera disposed at an angle to said surface opposite to the angle of said illumination source and capturing reflected light from the entire wafers surface without eclipse, in a duple of consecutive, properly delayed imaging shots and providing appropriate image resolution for tiny residue detection;
computation means, implementing image processing and manipulation algorithms to enable residue detection and characterization and providing for logic and command operations execution and camera control;
said computation means accumulating an on-line created wafer images and wafer residue defects data base, and
providing for inspection tool worthiness monitoring.

2. The apparatus as claimed in claim 1, further comprising:
a parent tool wafer-handling and transportation means contained in an output stage robot;
said inspection tool includes a support structure, mounted on a parent tool chassis;
said computation means including an information exchange interface with a parent tool operator via computer screen, with process floor host, and with the parent tool electrical trigger module, and
said parent tool operator executing the man-in-the-loop control functions.

3. The apparatus as claimed in claim 2, wherein said inspection tool is an on-process integrated added-on washer-scrubber tool or an integrated polishing machine.

4. The apparatus as claimed in claim 1, wherein said inspection process of said inspection tool and results analysis and action taken, is controlled solely by a host computer.

5. The apparatus as claimed in claim 1, wherein the inspection tool's image processing system additionally executes wafer's front-side marking bar-code reading and/or wafer identification marks reading, with consequent reading results incorporation in the information fed to data base and host.

6. The apparatus as claimed in claim 1, wherein the inspection tool incorporates auxiliary means for wafer's-under-inspection backside marking imaging and processing means for bar-code reading and/or wafer identification marks reading, with consequent reading results transfer to data base and host.

7. The apparatus as claimed in claim 2, wherein said parent tool output stage robot, or a stand alone robot's wafer grip, is configured such that the wafer's surface image acquisition and processing are performed in a single imaging frame.

8. The apparatus as claimed in claim 1, wherein the inspection tool's camera focal plane centre and illumination source central point are displaced in horizontal direction relative to inspected wafer centre, in addition to their vertical displacement and rotational inclination of the preferred embodiment.

9. The apparatus as claimed in claim 1, wherein said illumination source and camera are coaxially arranged, providing for instantaneous front surface coverage in a single shot frame and minimization of the image's perspective geometrical distortions.

10. The apparatus as claimed in claim 1, wherein the illumination source and said camera are both inclined by substantially as 30° angle at opposite directions relative a vertical, preserving the bright field imaging scheme.

11. The apparatus as claimed in claim 1, wherein the inspection tool is aimed and configured to copper CMP residues and other planarization process flaws inspection and detection.

12. The apparatus as claimed in claim 1, wherein said automatic optical inspection is capable of inspecting semiconductor production wafer's macro defects including, lithography, bumping, back-side and edge defects, in addition to polishing residues detection.

13. A method of automatic optical self-contained inspection for pattern wafers' polishing residue detection with sub-pixel defect size effective spatial sensitivity, based on wafer-under-inspection surface light scattering colour-intensity computerized analysis, comprising the steps of:
setting-up initial calibration and correction data derivation;
wafer image acquisition and rendering;
lighting intensity and camera sensitivity colour spectra biases and spatial variances compensation;
duple images registration and merging for full wafer surface inspection execution;
self-contained image scattering intensity analysis for outstanding, amplitude and colour-ratio comparison based, residue-covered areas discriminating against the patterned wafer area portions, not containing polishing residue defects, and
image rectification and inspection results on-screen presentation containing wafer-under-inspection zoomed image and corresponding emphasized detected residues image.

14. The method as claimed in claim 13, comprising additional steps of detected defects characterization and metrology quantitative results derivation and presentation.

15. The method as claimed in claim 13, comprising an additional step of automatic residue defects classification according to their potential harm evaluation and polishing tool malfunctioning appropriate alarm.

16. The method as claimed in claim 13, comprising an additional step of an inspection tool and its interface with a parent tool worthiness monitoring and proper worthiness-related messages generation and presentation.

17. The method as claimed in claim 13, comprising an additional step of a parent tool robot worthiness monitoring based on the wafers' images position and its deviations analysis.

18. The method as claimed in claim 13, comprising an additional step of inter-lot and intra-lot wafers' inspection outcome information integrative analysis for automatic inspection tools, parent tools and polishing process worthiness evaluation and malfunction prediction.

19. The method as claimed in claim 13, comprising an additional MMI step of inspection results presentation on the tool screen to allow a process operator to scroll through wafer's lot-under-inspection or any previously inspected lot's acquired images and residue detection results images saved in data base, for said lot's wafers' quality and inspection and polishing tool's worthiness assessment.

20. The method as claimed in claim 13 implementing a calibrating step and calibration parameters derivation by means of analyzing and processing fully Tungsten covered wafer images.

21. The method as claimed in claim 20 implementing automatic, computer-driven camera parameters dynamic adjustment during calibration procedures, allowing seamless inspection tool integration and maintenance on the plentitude of parent tool specimens and amid their inter-tool manufacture tolerances and intra-tool operational variances.

22. The method as claimed in claim 13, incorporating inspection tool camera and illumination source luminance and sensitivity tolerances and dynamic changes automatic on-process compensation and worthiness assessment, by fully Tungsten covered wafer operational inspection event recognition and compensation parameters values update.

23. The method as claimed in claim 13, comprising an additional step of spatially variable residue detection threshold scheme, thus implementing CFAR and enhancing inspection sensitivity.

24. The method as claimed in claim 13, comprising an additional step of pixels basic colours' three inter-ratios analysis method for residue's assumed detection verification.

25. The method as claimed in claim 13, comprising an additional step of non-Tungsten polishing harmful remains detection, including pre-determined colour ratios verification quantitative criteria definitions, different from the ones used for Tungsten presence verification and based on a specific material residue scattering colour spectra.

26. The method as claimed in claim 13, comprising an additional step of silicon layer averaged thickness and its variations spatial distribution over wafer surface estimation, based on a reflected light colour spectra interference analysis.

27. The method as recited in claim 13, comprising an additional step of patterned wafers surface over-polish presence detection and quantification.

28. The method as claimed in claim 13, comprising residue-detection oriented and computationally shy algorithms for image registration.

29. The method as claimed in claim 13, comprising an additional image registration procedure step of tool-to-tool and wafer-to-wafer variable skew correction.

30. The method as claimed in claim 13, comprising an additional step of on-line data base creation, kept in the inspection tool processor storage and containing information and data pertinent for residue events post-inspection yield, polishing tools worthiness and impairment prognosis and preventive maintenance-oriented analysis.

31. The method as claimed in claim 13, comprising an additional non-operational inspection step with images retrieval from data base, instead from camera as in operational mode, allowing for inspection tool computational analysis worthiness as well as previously not encountered wafer's scattering features investigation and inspection tool processing algorithms alternations testing.
